(19) United States
(12) Patent Application Publication
(10) Pub. No.: US 2008/0208794 A1
(43) Pub. Date: Aug. 28, 2008

(54) METHOD, SYSTEM, AND COMPUTER PROGRAM PRODUCT FOR INTEGRATING DATA BETWEEN DISPARATE AND HOST SYSTEMS

(75) Inventors: TAHIRISOA ANDRIAMANANJARA, Roseville, MN (US); Wayne R. Smith, Ham Lake, MN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Medical-Surgical Minnesota Supply Inc.

(21) Appl. No.: 12/035,781

(22) Filed: Feb. 22, 2008

Related U.S. Application Data
(60) Provisional application No. 60/891,134, filed on Feb. 22, 2007.

(51) Int. Cl. G06F 17/30

(52) U.S. Cl. 707/1; 707/E17.001

(57) ABSTRACT

A method, system, and computer program product are provided for integrating one or more disparate systems with a host system. For example, a computer program product including at least one computer-readable storage medium having computer-readable program code portions stored therein includes a first executable portion for receiving data associated with at least one order for at least one product or service at a disparate system. The computer program product also includes a second executable portion for defining a first format for one or more files associated with at least a portion of the data at the disparate system. In addition, the computer program product includes a third executable portion for providing the one or more data files defined in the first format to a host system to be configured into a second format that is different than the first format and compatible with the host system. The computer program product further comprises a fourth executable portion for accessing a plurality of different predefined translation routines and translating the one or more files defined in the first format into the second format.

### CROSS REFERENCE TO RELATED APPLICATION(S)

This application claims the benefit of U.S. Provisional Patent Application No. 60/891,134 filed Feb. 22, 2007, the content of which is incorporated herein in its entirety.

### BACKGROUND OF THE INVENTION

1. Field of the Invention

Embodiments of the present invention relate to integrating data between disparate and host systems and, more particularly, to integrating data provided by disparate systems with the host system using a self-configurable interface.

2. Description of Related Art

Consumers transact with retailers in a variety of manners, such as by purchasing an item from a retailer on the retailer's website. When the consumer purchases an item, the consumer may enter the details of the order on the retailer's website, while a third party (e.g., distributor) may supply the product. The retailer is then required to supply the order information to the distributor in order to receive the product such that the retailer may need to reenter the order information. In order to alleviate the duplicity of reentering orders, the distributor's IT staff may need to confer with its customer's IT programming staff, e.g., a retailer's IT staff, to hardcode a program to export a data set that is acceptable by the distributor's system, which may be time consuming and require testing to implement. In addition, the customer's IT resources may be scarce such that providing quality IT support may be limited. For example, in markets such as the home care marketplace, the customer may not have IT resources at all. Moreover, corporate customers sometimes employ traditional EDI (electronic data interface) X12 standards, which may be expensive to work with due to the staffing and programming necessary. In addition, smaller companies may be at a disadvantage when purchasing from a third party (e.g., a distributor) where their software packages are generic and do not have the software or programming capabilities to access the third party's system to place an order. Furthermore, many customers cannot afford the technical resources and expertise needed to build an interface for every vendor system, so a common solution is to have no interface at all, requiring customers to re-type orders into the third party's system.

Therefore, retailers may be unable to move back and forth between their backend system and a third party's system. For instance, in the home care market place, retailers (e.g., home health agency) have patient information (e.g., name and address of the ultimate consumer) stored for shipping a particular product to their home or to an agency. Similarly, a consumer may place an order online or via telephone from a retailer. But, in order for the distributor to supply the product, the distributor needs the patient's information. Despite the fact that the retailer has the patient information stored in their backend system, the retailer must frequently reenter the information for the distributor, thereby resulting in an inefficient and inconvenient ordering process.

A further issue relates to providing information electronically to customers. For example, many customers would prefer to receive an electronic invoice from the third-party distributor rather than a paper copy. Some of the information may be emailed rather than transmitted via an interface (e.g., invoices and credit memos may be converted to a specific file format and emailed), which may be time consuming and inconvenient to manage. Additionally, customers may also receive paper invoices and credit memos by mail several days after an order ships (or emails of common file types), manually check an internet website for shipping status, and mail disks of patient, formulary, and general ledger information for manual upload by the third-party distributor.

Therefore, it would be advantageous to provide a non-programming method for integrating data from a disparate system, such as that operated by a customer, with a host system, such as that operated by a distributor. In addition, it would be advantageous to provide a method that reduces the manual processes needed, is cost efficient, increases transaction speed, and results in a higher level of customer satisfaction.

### SUMMARY OF THE INVENTION

Embodiments of the present invention relate to a method, system, and computer program product for integrating one or more disparate systems with a host system. For example, the method includes receiving data associated with at least one order for at least one product or service at a disparate system and defining a first format for one or more files associated with at least a portion of the data at the disparate system. The method also includes providing the one or more files defined in the first format to a host system to be configured into a second format that is different than the first format and compatible with the host system. Moreover, the method includes accessing a plurality of different predefined translation routines and translating the one or more files defined in the first format into the second format.

According to aspects of the method, the defining step includes receiving a selection of one or more file types associated with the respective one or more files, wherein the one or more file types may be purchase orders, invoices, credits, shipment notifications, patient uploads, and/or caregiver uploads. The defining step may also include receiving a selection of one or more file extension types associated with the respective one or more files, and/or receiving a selection of one or more file formats associated with the respective one or more files. Furthermore, the defining step may include receiving a selection of a file layout associated with the respective one or more files, wherein the file layout comprises a plurality of required fields and optional fields that correspond to a file layout of the respective one or more files. The defining step may also include receiving a selection of a date and time format associated with the respective one or more files, and/or receiving a selection of a file location associated with the respective one or more files. According to an additional aspect, the method includes storing the data at the disparate system, and the providing step may include directly providing the one or more files to the host system or allowing the host system to access the one or more files at the host system.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a system for integrating a disparate system with a host system according to one embodiment of the present invention;

FIG. 2 shows a flowchart for receiving a request for a product and service and providing the product or service according to one embodiment of the present invention;

FIGS. 3-8 illustrate screen shots for an installation procedure for uploading a software interface to a disparate system according to an embodiment of the present invention;

FIGS. 9-14 illustrate exemplary screen shots for setting up a software interface at a disparate system according to one embodiment of the present invention;

FIG. 15 depicts a screen shot of a home screen for an interface used for configuring data from a disparate system according to one embodiment of the present invention;

FIG. 16 shows a screen shot of a purchase order screen for entering an account number and file location to be used for configuring data from a disparate system according to one embodiment of the present invention;

FIG. 17 depicts a screen shot of a configuration wizard screen for selecting files to be configured by a host system according to one embodiment of the present invention;

FIG. 18 depicts a screen shot of a file extension screen for entering a file extension to be used for configuring data from a disparate system according to one embodiment of the present invention;

FIG. 19 depicts a screen shot of a file type screen for entering the type of file and delimiters to be used for configuring data from a disparate system according to one embodiment of the present invention;

FIG. 20 depicts a screen shot of a file layout screen for entering fields to be used for configuring data from a disparate system according to one embodiment of the present invention;

FIG. 21 depicts a screen shot of a date/time screen for entering the date and time formats to be used for configuring data from a disparate system according to one embodiment of the present invention;

FIG. 22 depicts a screen shot of a file location screen for entering a location of the files to be used for configuring data from a disparate system according to one embodiment of the present invention; and

FIG. 23 depicts a screen shot of a completion screen for submitting files from a disparate system to be configured at a host system according to one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

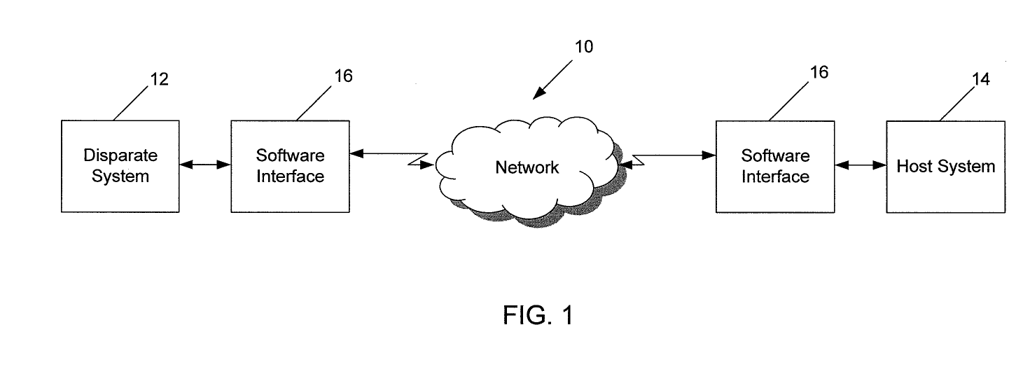

Referring to FIG. 1, there is shown a system 10 for integrating a disparate system 12 with a host system 14. The disparate 12 and host 14 systems are in communication via a network and respective software interfaces 16 for integrating data provided by the disparate system with a data format used by the host system. In general, the software interfaces 16 are self-configurable to enable the disparate system 12 to define data stored at the disparate system in a first format that may be converted into a second format that is compatible with the host system 14. Thus, the user of the disparate system 12 may not be required to manually reenter the information or independently program the disparate system into a format that is compatible with the host system.

One or more host systems 14 may be in communication with one or more disparate systems 12 within the network. For example, the host system 14 may be the computer system of a distributor or supplier for providing products or services, while each of the disparate systems 12 may be the computer system of a customer or retailer submitting an order to be fulfilled for a consumer. According to one aspect, the host system 14 is the computer system of a distributor of medical products or services, and the consumers for which the retail customer is fulfilling the order are patients or home health agencies requesting a particular medical product or service from the disparate system 12. Thus, the terms “disparate” and “host” are not meant to be limiting, as the disparate system may be any system configured to communicate in a data format that may differ from a host system. For example, using the system 10, medical product orders and invoices, credit memos, shipment notifications, patient information, insurance information, rules relating to a patient's access to particular products, general ledger code information, and product formularies may be transmitted between the disparate system 12 and the host system 14 without requiring the user of the disparate system to alter the particular format of the data transmitted, such as by reentering at least some of the data. Additionally, it is understood that the disparate 12 and host 14 systems are not limited to use within the health care industry, as the system 10 of the present invention is applicable to any number of industries for providing a variety of products and services.

As also used herein, the term “system” may correspond to any suitable computing device, typically a computer (e.g., client or server), a personal data assistant, a mobile phone, or the like, capable of transmitting and/or receiving information via a network. For example, the disparate system 12 may be a client device, while the host system 14 may be a server, such that the system 10 operates in a client-server network. Likewise, each system may be generally comprised of one or more computing devices each having at least one or more processors and associated memory device(s) as known to those skilled in the art. Each system may comprise any number of conventional components but typically includes a bus, central processing unit (CPU), read-only memory (ROM), random access memory (RAM), storage device, input/output controller, network interface, and programs having software, as all known to those skilled in the art.

The network may be any suitable network for facilitating communication between the disparate 12 and host 14 systems. For example, the network may be a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet, an extranet, or any other suitable network.

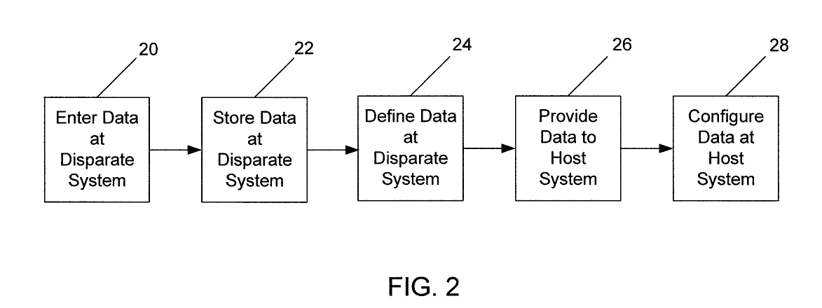

FIG. 2 generally depicts a method for processing requests for a product or service according to one embodiment of the present invention. A consumer desiring to purchase a product or service typically enters information that is used for fulfilling the order (block 20). For instance, a patient may enter his or her name, address, phone number, the product desired, and the product quantity. The consumer may enter this information on an interface provided by a disparate system 12, such as the system hosting a retailer's website. The information entered at the retailer's website may be stored or cached in a memory at the disparate system 12 (block 22), which could be accessed for requesting the product from the third-party distributor and for shipping the product. The information could be stored at the disparate system 12 in a variety of formats, such as using a complex management application or a spreadsheet. Using a software interface 16, a user of the disparate system 12 is capable of redefining the data stored in memory so that the data may be configured into a format that is compatible with the host system 14 (block 24). As explained in further detail below, the interface 16 is self-configurable which allows the user of the disparate system 12 to provide information to the host system 14 without altering the format of the stored data and without requiring the generation of customized code for performing the translation. Alternatively, the disparate system 12 may access a format that was previously defined for the data such that the disparate system does not need to redefine the data. After the user of the disparate system 12 provides the necessary information to redefine the format of the data, the data is provided to the host system 14 (block 26). Alternatively, the host system 14 may retrieve the data file from the disparate system 12. Using the data provided from the disparate system 12, the host system 14 is capable of configuring the data (block 28) and providing the product to the consumer using the data provided by the disparate system 12, as well as providing various information (e.g., invoices) to the disparate system electronically via the network. For example, the host system 14 may convert the data file into an XML format to generate a website that includes information relating to the data provided by the disparate system 12. The website could be private, public, or semi-public for allowing its customers (e.g., disparate system 12) to access processed orders and information related thereto (e.g., invoices). In addition, the host system 14 could send information directly to the disparate system 12 when the information becomes available or when the disparate system requests such information.

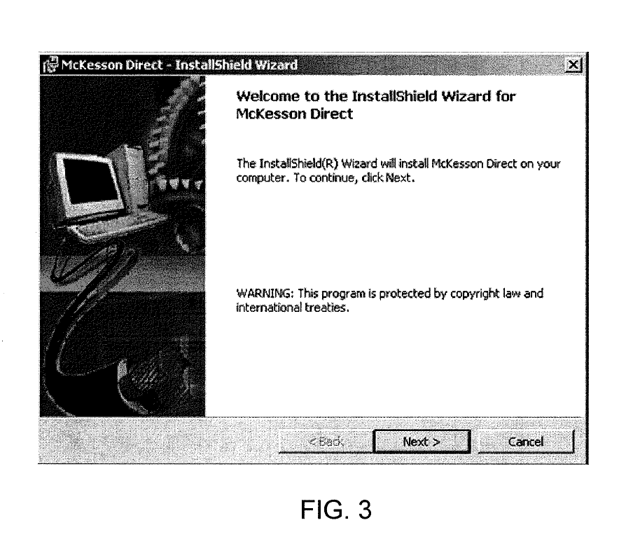

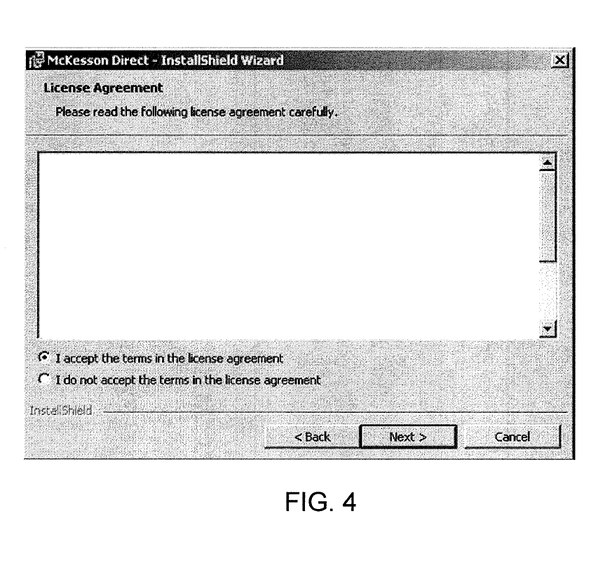

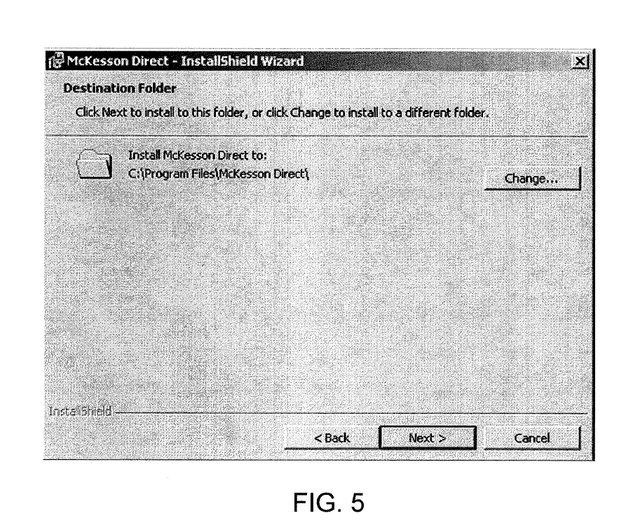

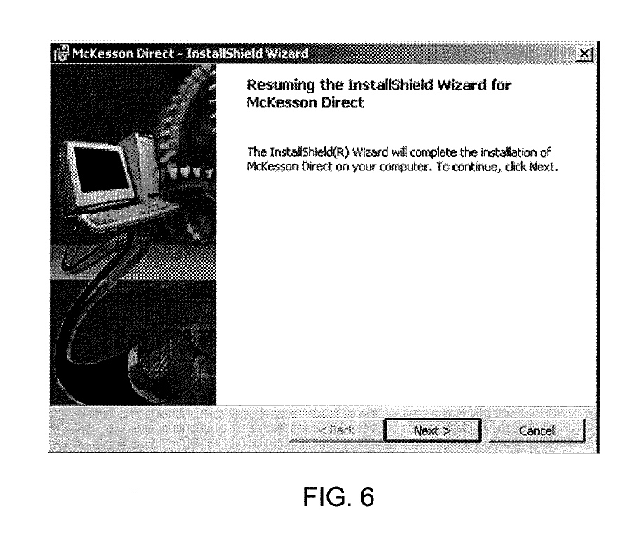

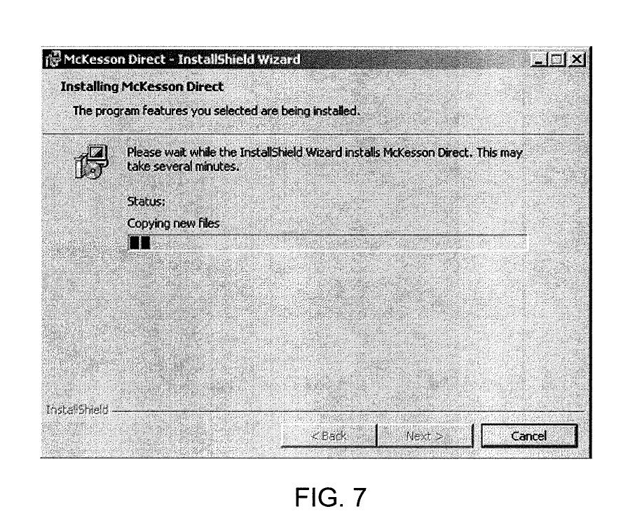

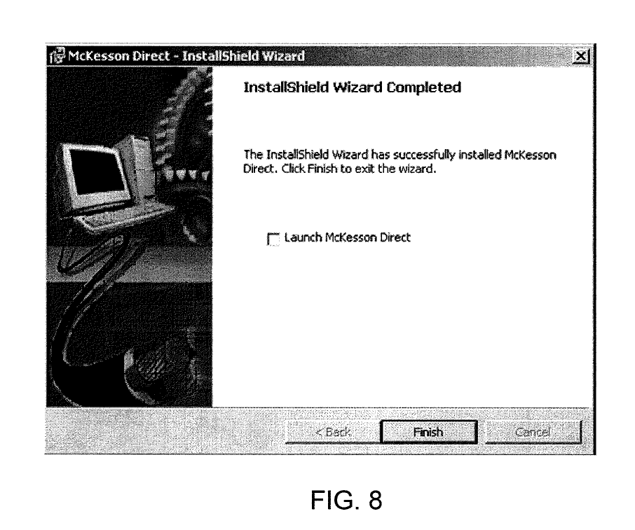

The program for operating the software interface 16 could be downloaded (e.g., via a disk or directly from the host system 14) to the disparate system 12 such that manual programming or programming assistance from the host system 14 may be unnecessary. For example, FIGS. 3-8 illustrate an installation procedure for uploading the software interface 16 to the disparate system 12, whereby the installation procedure executes on the disparate system following uploading of the software that defines the installation procedure from the host system 14. In particular, the installation procedure includes prompting the user to accept a licensing agreement with the host system 14 and install the software to a particular location at the disparate system 12. FIGS. 3-8 demonstrate that the installation procedure may include several user-friendly prompts for guiding the user through the installation process.

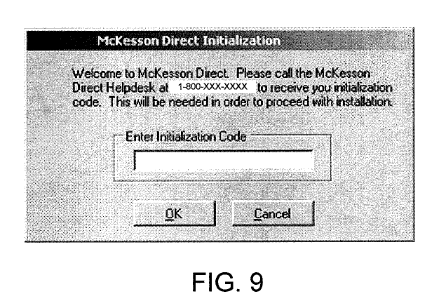

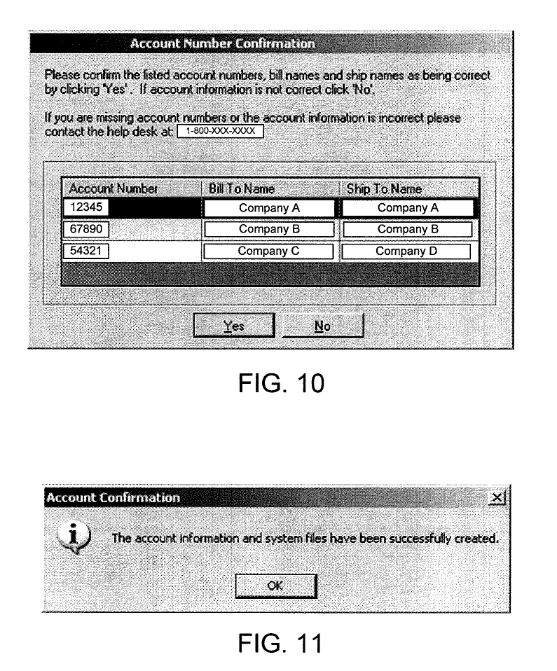

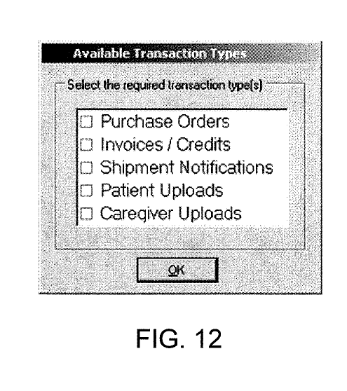

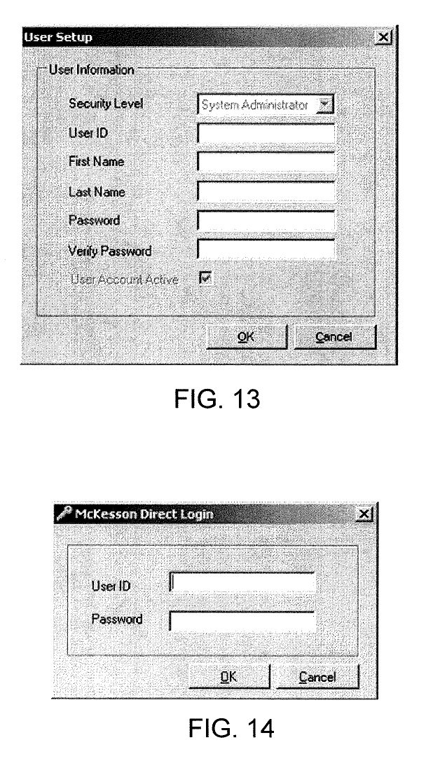

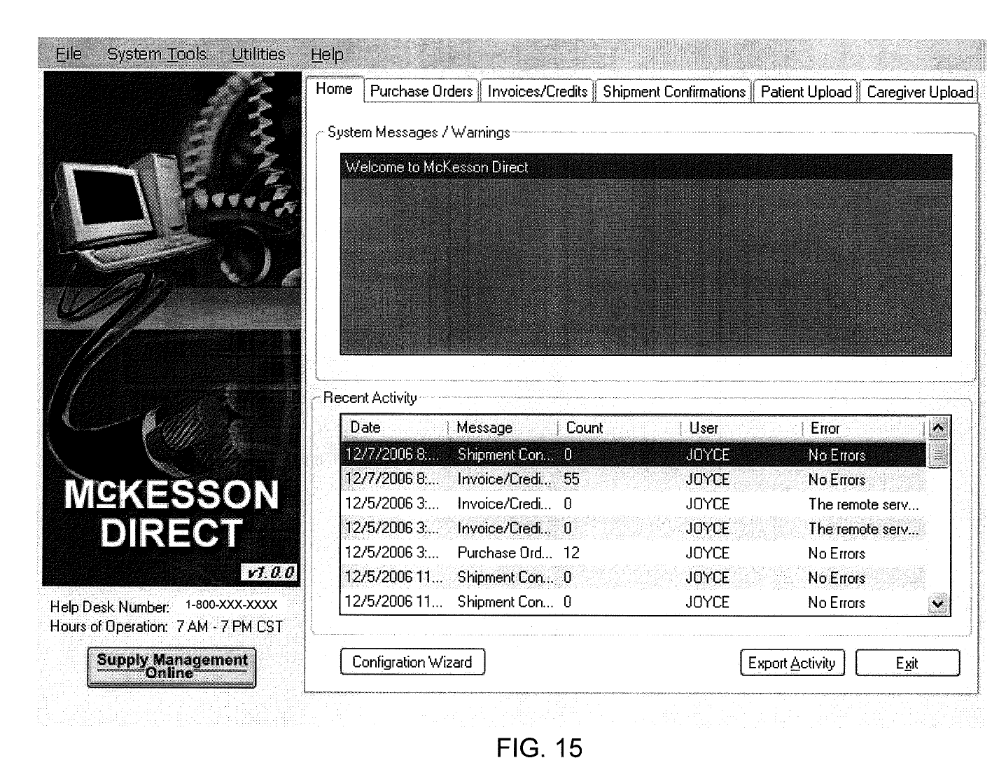

FIGS. 9-14 illustrate exemplary screen shots for setting up the software interface 16 for use at the disparate system 12 according to one embodiment of the present invention. For identification purposes, the user of the disparate system 12 may be requested to provide an initialization code or other code identifying the user (FIG. 9). FIG. 10 shows an interface for setting up one or more account numbers at the disparate system 12 that corresponds to a particular file to be transferred to the host system 14. By selecting a particular account number and the “yes” button, an account is created (FIG. 11), while selecting the “no” button exits the application. FIG. 12 depicts several options that the user of the disparate system 12 may select for available transaction types that the user desires to transfer to or receive from the host system 14, such as purchase orders, invoices/credits, shipment notifications, patient uploads, and caregiver uploads. The selected transaction types may be available to the user upon startup of the software interface 16. FIGS. 13 and 14 illustrate that the user of the disparate system 12 may be required to enter a user ID, name, and password for security purposes. Typically, FIG. 13 corresponds to information requested for a first time user of the software interface 16, and selecting the “OK” button prompts the user to enter the newly created user and password, as shown in FIG. 14 so that the user may access the software interface.

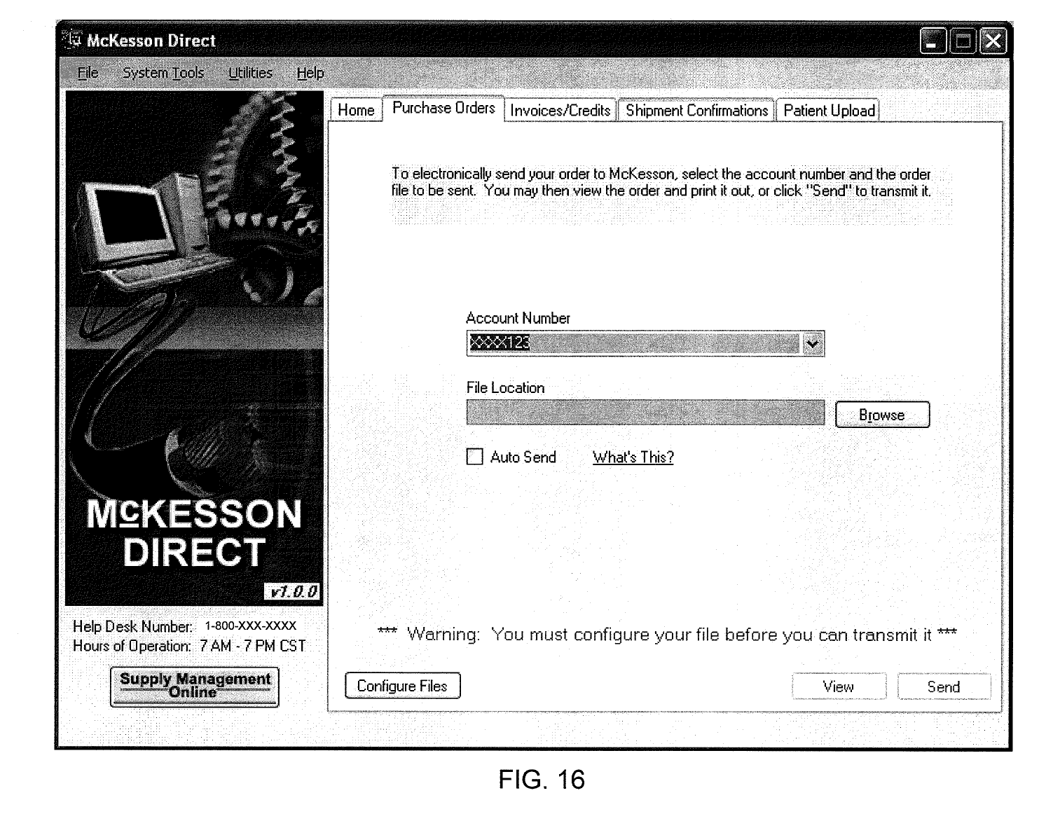

FIGS. 15-23 illustrate exemplary screen shots of a software interface 16 residing at a disparate system 12 according to one embodiment of the present invention. In particular, FIG. 15 illustrates a screen shot of a home screen that includes recent activity for a particular disparate system 12, such as recent shipments, invoices, and purchase orders. The home screen includes various options for “purchase orders,” “invoices/credits,” “shipment confirmations,” “patient upload,” and “caregiver upload.” FIG. 16 illustrates a screen shot corresponding to the “purchase orders” tab selected from the home screen. The purchase orders tab includes an option to enter an account number and file location for the purchase order that is ultimately provided to the host system 14.

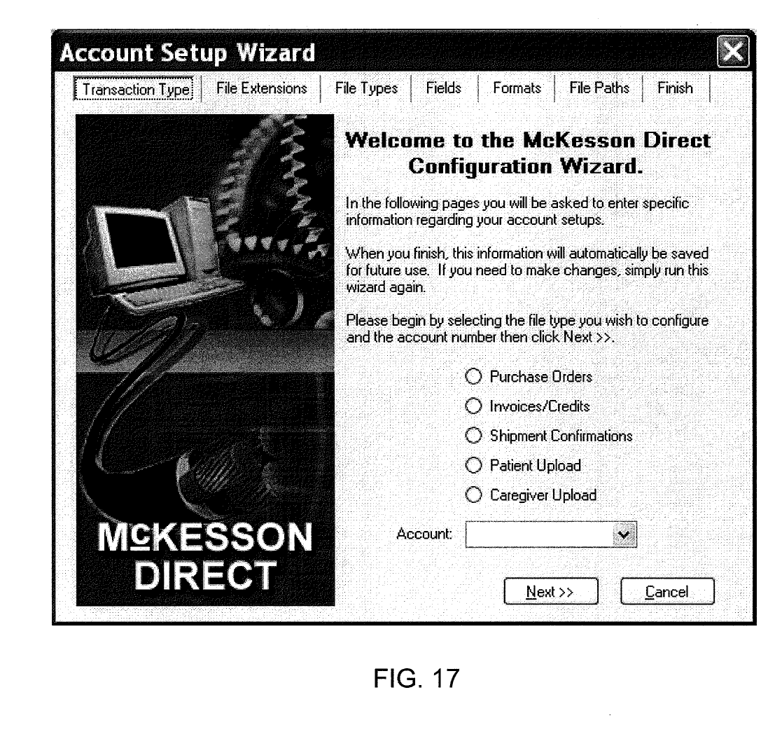

In addition, FIG. 16 illustrates that the purchase orders tab includes an option for “configure files.” Selecting the “configure files” tab provides the screen shot shown in FIG. 17. To define the data at the disparate system 12 to be configured at the host system 14, a configuration wizard is employed. The configuration wizard requests specific information from the disparate system 12 so that the user of the disparate system may provide a particular file to the host system 12 using the current format of the data at the disparate system. In this regard, FIG. 17 illustrates that the user of the disparate system 12 may request various exemplary files to be configured, such as purchase orders, invoices/credits, shipment confirmations, patient upload, and caregiver upload. Although the files to be configured may vary depending on the particular product or service requested, as well as the particular disparate 12 and host 14 system, purchase orders generally relate to an actual request for purchasing a product or service, and invoices/credits relate to the amount owed for the product or service and credits provided to account for the amount owed. Moreover, shipment confirmations generally relate to notification that a particular product has been shipped, while patient and caregiver uploads relate to information associated with a patent or caregiver that is stored at the disparate system 12 and that may be uploaded to the host system 14.

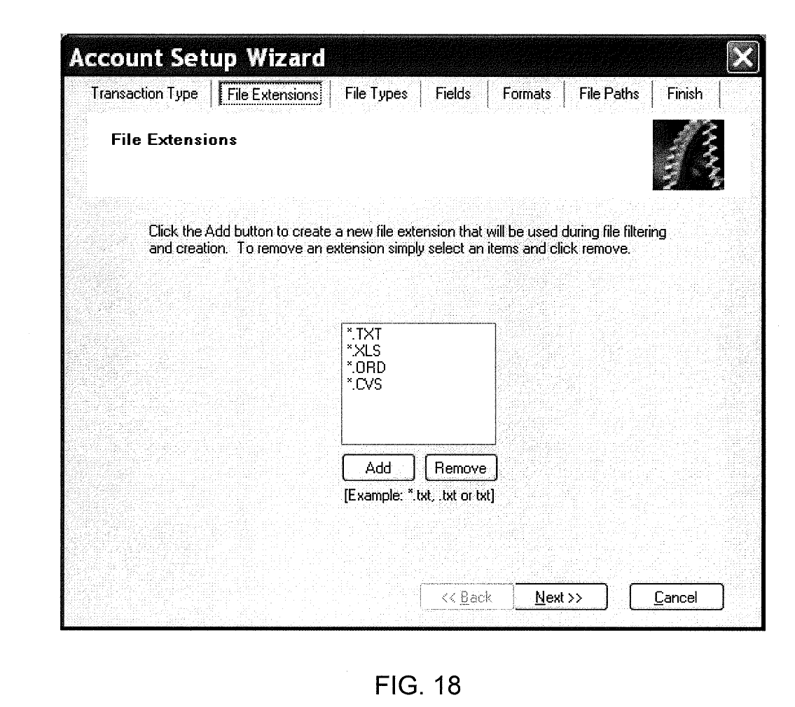

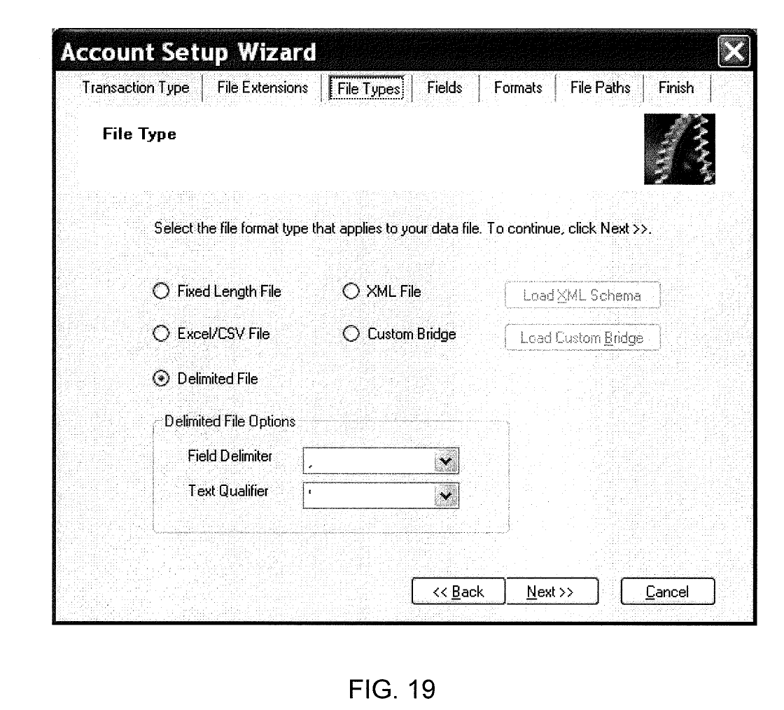

Upon selecting the files to be configured, the user of the disparate system 12 is requested to enter the specific file extension of the data as currently stored by the disparate system, as shown in FIG. 18. Any number of file extensions may be used for the data. For instance, non-limiting examples include *.TXT, *.XLS, *ORD, *CVS, *DATA, *.INF, and *MDC file extensions. FIG. 18 also demonstrates that the user of the disparate system 12 may modify the particular file extension that may be selected, such as by adding or removing a particular file extension. FIG. 19 illustrates that after the user has selected the appropriate file extension, the user of the disparate system 12 is prompted to select a file format type that corresponds to the data stored at the disparate system. For instance, FIG. 19 shows that the file types could be fixed length files, XML files, Excel/CSV files, Custom Bridge files, or Delimited Files. Selecting the Delimited file type further requests the user to enter a field delimiter and a text qualifier. Furthermore, FIG. 19 shows that selecting the XML file or Custom Bridge file would allow the user of the disparate system 12 to load XML Schema (i.e., particular XML language) or a Custom Bridge, respectively.

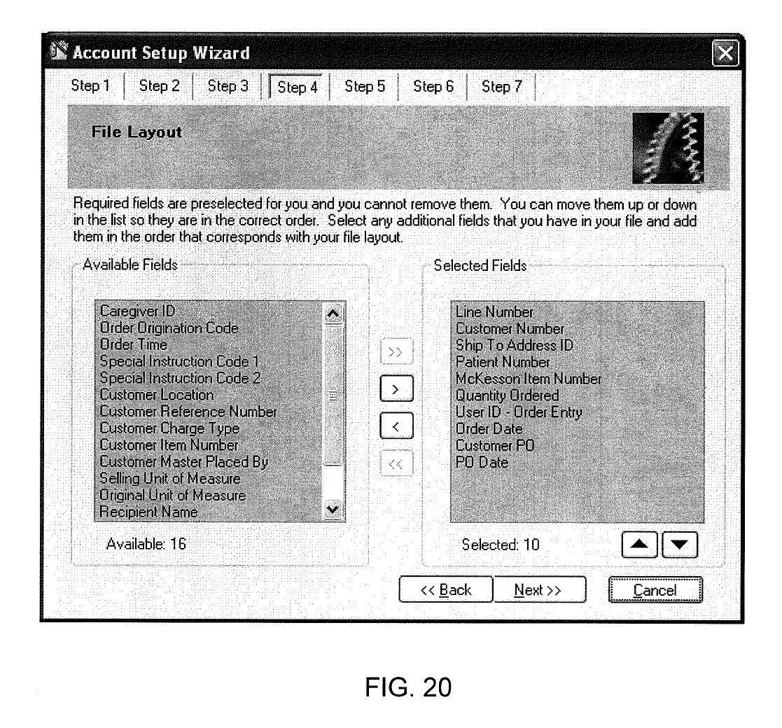

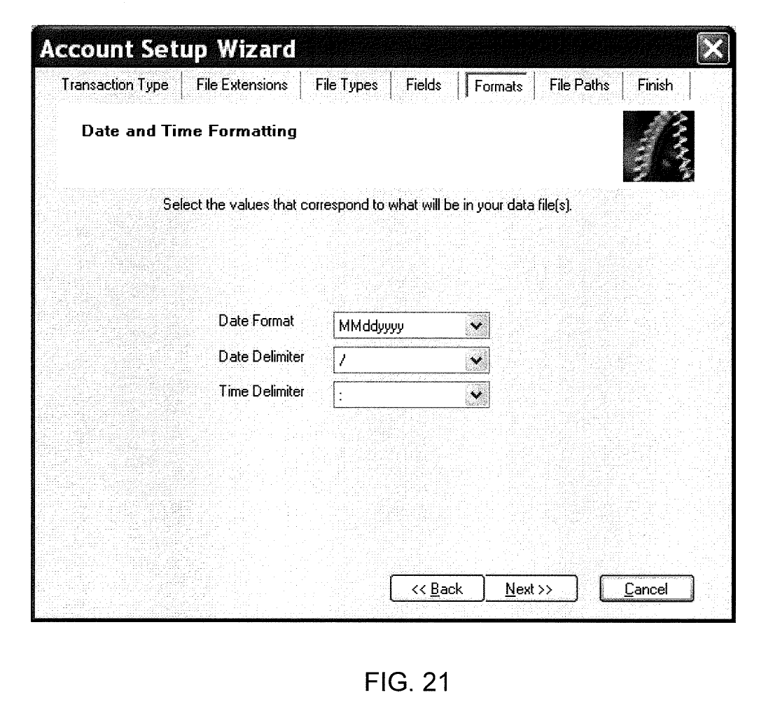

FIG. 20 demonstrates that the user of the disparate system 12 is capable of defining the file layout to be provided to the host system 14. In particular, FIG. 20 shows that the user of the disparate system 12 may select available fields from a list that corresponds to the fields included in the data at the disparate system. For example, the fields may be a caregiver ID, order origination code, order time, customer location, customer item number, ship to address, and quantity ordered. Some of the fields may be preselected and are, thus, mandatory fields. For instance, the patient number and shipping address may be mandatory fields. The user of the disparate system 12 is capable of adding, deleting, or changing the order of particular fields into a format that corresponds to the format of the disparate system's current data file. As shown in FIG. 21, the user of the disparate system 12 may also input data and time formatting that corresponds to the current format of the data file stored at the disparate system. For instance, the user may select the date format, date delimiter, and time delimiter.

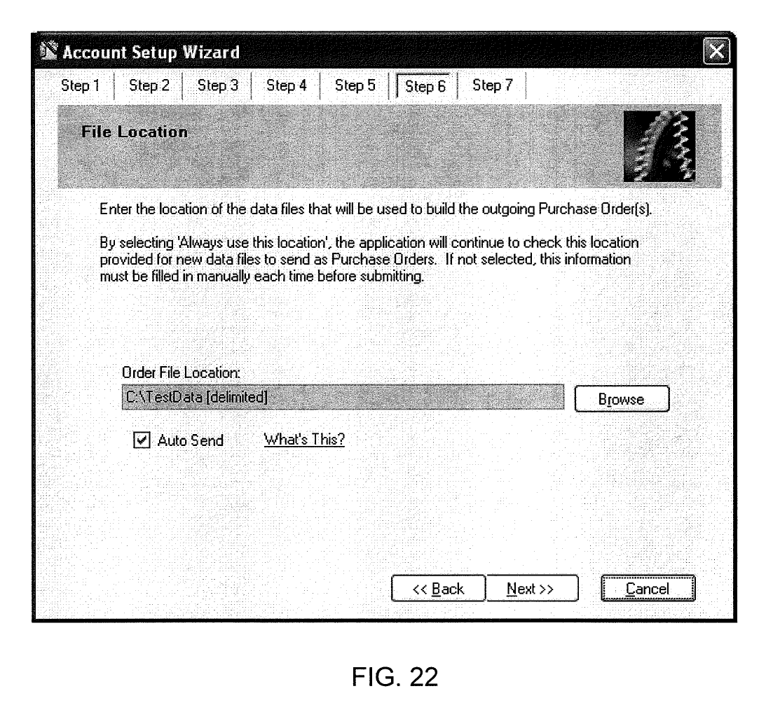

Moreover, FIG. 22 illustrates that the user of the disparate system 12 is requested to enter a file location at which the data file is stored. The user may select that the file will always be at this particular location such that the host system 12 may periodically or continuously monitor the location for new purchase orders. For instance, uploads of the patient and caregiver data may occur at various times, such as each time the user of the disparate system logs on to the software interface 16, or the disparate system could monitor its database for updates to the patient or caregiver data and transmit the data to the host system 14 in real time. Alternatively, the user of the disparate system 12 may manually submit the file location before submitting a file to the host system 14.

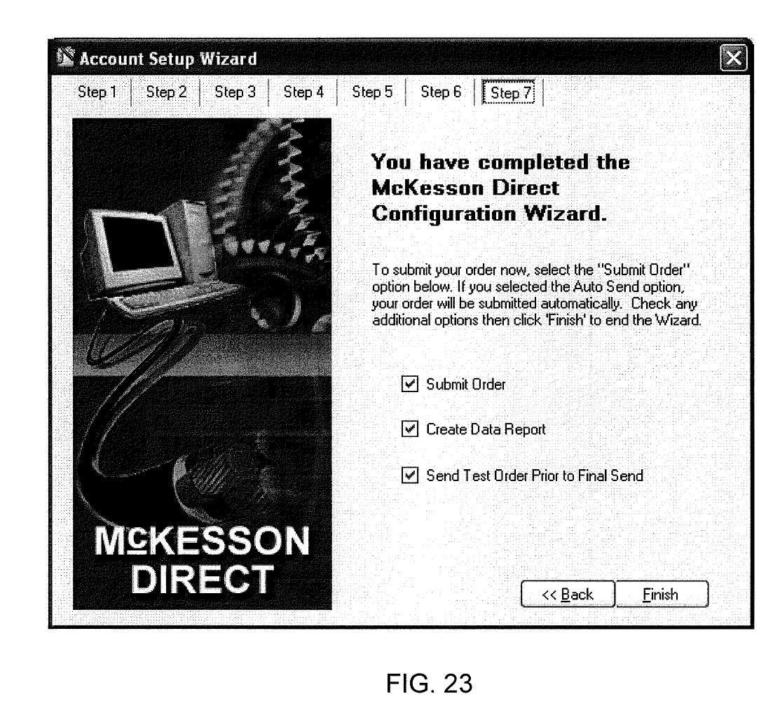

FIG. 23 shows a screen shot that indicates that the user of the disparate system 12 has completed the configuration wizard. The user is then capable of submitting the order, creating a data report, and/or sending a test order prior to sending the file to the host system 14. The user may utilize the test order option to ensure that the user has provided accurate and sufficient information that may be submitted to the host system 14 to be configured. It is noted that at any time during use of the configuration wizard, the user may access previous information by selecting the “back” button or cancel the configuration wizard by selecting the “cancel” button.

Based upon the configuration information provided via the configuration wizard, an interface 16 is automatically constructed to translate the data stored by the disparate system 12 at the file location with the file extension having the file type and file layout specified by the user to a format that is acceptable by the host system 14. Thus, the software that generates the graphical interfaces shown in FIGS. 15-23 also includes or is capable of accessing a plurality of different predefined translation routines that translate the data stored by the disparate system 12 at the file location with the file extension having the file type and file layout specified by the user to a format that is acceptable by the host system 14. Thus, the software underlying the configuration wizard is capable of providing the necessary translation routine without need for IT resources to customize and/or hardcode the interface and with only limited input required of the user. By permitting the software underlying the configuration wizard to select from a wide variety of translation routines, the configuration wizard is quite flexible and capable of working with a wide variety of different formats, file extensions, etc.

It is understood that the screenshots show in FIGS. 3-23 and discussed above are not meant to be limiting, as the software interface 16 at the disparate system 12 may be installed, setup, and used in a variety of formats using a variety of information. For example, the configuration wizard depicted in FIGS. 15-23 could include any number of prompts and formats for selecting various information to assist the user of the disparate system 12 to self-configure its data files to be configured by the host system 12. Moreover, although the software interface 16 is discussed above in conjunction with the disparate system 12, it is understood that the host system 16 may include similar functionality. For example, the user of the host system 14 may self-configure a format that will be used to translate incoming data into the desired format. However, the software interface 16 of the host system 14 need not necessarily be as flexible in defining a particular format to be used as the software interface 16 at the disparate system 12, as the host system converts the data provided by the disparate system into its own format rather than having to convert its data into another compatible format.

Therefore, embodiments of the present invention may provide several advantages. For example, each disparate system 12 is capable of utilizing its current format for files such that the data does not need to be reentered when requesting a product or service from the host system 14. Thus, the disparate system 12 may transmit to and receive data from the host system 12 efficiently and in a user-friendly manner. In particular, manual programming is not necessary due to the self-configurable interface residing at the disparate system 12 and the translation of the data format at the host system 12.

FIG. 2 is a flowchart of a system, method, and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart's block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer program product comprising at least one computer-readable storage medium having computer-readable program code portions stored therein, the computer-readable program code portions comprising:
a first executable portion for receiving data associated with at least one order for at least one product or service at a disparate system;
a second executable portion for defining a first format for one or more files associated with at least a portion of the data at the disparate system;
a third executable portion for providing the one or more files defined in the first format to a host system to be configured into a second format that is different than the first format and compatible with the host system; and
a fourth executable portion for accessing a plurality of different predefined translation routines and translating the one or more files defined in the first format into the second format.

2. The computer program product of claim 1, wherein the second executable portion comprises instructions for receiving one or more file types, file extension types, file formats, file layouts, date and time formats, and/or file locations associated with the respective one or more files.

3. The computer program product of claim 2, wherein the one or more file types comprise at least one of purchase orders, invoices, credits, shipment notifications, patient uploads, and caregiver uploads.

4. The computer program product of claim 2, wherein the file layout comprises a plurality of required fields and optional fields that correspond to a file layout of the respective one or more files.

5. The computer program product of claim 2, wherein the fourth executable portion is further configured to translate the data received by the disparate system using a file location, a file extension, a file type, and a file layout.

6. The computer program product of claim 1, further comprising a fifth executable portion for storing the data at the disparate system.

7. The computer program product of claim 1, wherein the third executable portion comprises instructions for directly providing the one or more files to the host system or allowing the host system to access the one or more files at the host system.

8. A method comprising:
receiving data associated with at least one order for at least one product or service at a disparate system;
defining a first format for one or more files associated with at least a portion of the data at the disparate system;
providing the one or more files defined in the first format to a host system to be configured into a second format that is different than the first format and compatible with the host system; and
accessing a plurality of different predefined translation routines and translating the one or more files defined in the first format into the second format

9. The method of claim 8, wherein defining comprises receiving a selection of one or more file types, file extension types, file formats, file layouts, date and time formats, and/or file locations associated with the respective one or more files.

10. The method of claim 9, wherein translating comprises translating the data received by the disparate system using a file location, a file extension, a file type, and a file layout.

11. The method of claim 9, wherein the one or more file types comprise at least one of purchase orders, invoices, credits, shipment notifications, patient uploads, and caregiver uploads.

12. The method of claim 9, wherein the file layout comprises a plurality of required fields and optional fields that correspond to a file layout of the respective one or more files.

13. The method of claim 8, further comprising storing the data at the disparate system.

14. The method of claim 8, wherein providing comprises directly providing the one or more files to the host system or allowing the host system to access the one or more files at the host system.

15. A system comprising:
at least one disparate system configured to receive data associated with at least one order for at least one product or service and define a first format for one or more files associated with at least a portion of the data;
at least one host system configured to access or receive the one or more files defined in the first format and configure the one or more files into a second format that is different than the first format and compatible with the at least one host system; and
at least one interface configured to access a plurality of different predefined translation routines and translate the one or more files defined in the first format into the second format.

16. The system of claim 15, wherein the at least one disparate system comprises a memory for storing the one or more files.

17. The system of claim 16, wherein the at least one host system is configured to access the memory.

18. The system of claim 15, wherein the at least one interface is configured to allow a user of the at least one disparate system to define the first format for the one or more files.

19. The system of claim 15, wherein the at least one interface is configured to allow a user to provide one or more file types, file extension types, file formats, file layouts, date and time formats, and/or file locations associated with the respective one or more files.

20. The system of claim 19, wherein the at least one interface is configured to translate the data received by the disparate system using a file location, a file extension, a file type, and a file layout.

21. The system of claim 15, wherein the at least one disparate system comprises a retailer of the at least one product or service.

22. The system of claim 15, wherein the at least one host system comprises a distributor of the at least one product or service.

23. The system of claim 15, wherein the at least one host system is configured to complete the at least one order for the at least one product or service based on the one or more files configured into the second format.

24. The system of claim 23, wherein the at least one host system is configured to at least one of provide data associated with the at least one completed order to the at least one disparate system or allow the at least one disparate system to access the data associated with the at least one completed order.

25. A computing device comprising:
at least one processor configured to:
receive data associated with at least one order for at least one product or service;
define a first format for one or more files associated with at least a portion of the data;
provide the one or more files defined in the first format to at least one other computing device to be configured into a second format that is different than the first format and compatible with the at least one other computing device; and
at least one interface configured to access a plurality of different predefined translation routines and translate the one or more files defined in the first format into the second format.

26. The computing device of claim 25, further comprising a memory for storing the one or more files.

27. The computing device of claim 25, wherein the at least one processor is configured to directly provide the data associated with the at least one order to the at least one other computing device or allow the at least one other computing device to access the data associated with the at least one order.

28. The computing device of claim 25, wherein the at least one interface is configured to allow a user to define the first format for the one or more files, wherein the first format comprises one or more file types, file extension types, file formats, file layouts, date and time formats, and/or file locations associated with the respective one or more files.

29. The computing device of claim 28, wherein the at least one interface is configured to translate the data received by the processor using a file location, a file extension, a file type, and a file layout.
